(19) United States
(12) Patent Application Publication
(10) Pub. No.: US 2022/0228667 A1
(43) Pub. Date: Jul. 21, 2022

(54) BACK-PRESSURE CONTROL VALVE

(71) Applicant: SHIMADZU CORPORATION, Kyoto (JP)

(72) Inventor: Chihiro KORA, Kyoto (JP)

(21) Appl. No.: 17/616,635

(22) PCT Filed: Jun. 11, 2019
(86) PCT No.: PCT/JP2019/023155

§ 371 Date: Dec. 3, 2021

(51) Int. Cl. F16K 7/16; F16K 27/02

(52) U.S. Cl. CPC F16K 7/16; F16K 31/047; F16K 27/0236

(57) ABSTRACT

A back-pressure control valve includes a main body having an inner space, a valve element that is arranged in the inner space of the main body and has an opposing surface opposite to one surface of the inner space, a driver that moves the valve element such that a distance between the opposing surface of the valve element and the one surface in the inner space changes; and a resin coating formed on one of the one surface in the inner space and the opposing surface of the valve element, wherein the main body has a first flow path that guides a fluid to a pressure control space formed between another surface out of the one surface and the opposing surface of the valve element, and the resin coating, and a second flow path that discharges a fluid from the pressure control space.

### TECHNICAL FIELD

The present invention relates to a back-pressure control valve.

### BACKGROUND ART

In a supercritical fluid chromatograph (SFC), a supercritical fluid is used as a mobile phase. Generally, carbon dioxide is used as a supercritical fluid. In the supercritical fluid chromatograph, the pressure and temperature of carbon dioxide are controlled in order to keep the carbon dioxide supplied to a separation column in a supercritical state. A back-pressure control valve is used to control the pressure of carbon dioxide. For example, the pressure of carbon dioxide is controlled to be not less than 10 MPa by the back-pressure control valve. In Patent Document 1, a pressure control valve which is the back-pressure control valve is described.

The pressure control valve (hereinafter referred to as the back-pressure control valve) described in Patent Document 1 has a pressure control block formed of a hard material such as stainless. An opening is provided in one outer surface of the pressure control block, and a planar pressure control surface is formed on the bottom portion of the opening. In the pressure control block, an inlet flow path and an outlet flow path are formed. One end of the inlet flow path is connected to a flow path of the supercritical fluid chromatograph, and the other end opens at the pressure control surface. One end of the outlet flow path opens at the pressure control surface, and the other end is opened to an atmospheric pressure.

A sheet-like valve element is arranged above the pressure control surface in the opening. A gap is formed between the pressure control surface and the valve element. The gap amount between the pressure control surface and the valve element is adjusted by upward and downward movement of the valve element by an actuator. Thus, the pressure in the inlet flow path is adjusted.

[Patent Document 1] WO 2017/130316 A1

### SUMMARY OF INVENTION

### Technical Problem

In a supercritical fluid chromatograph, a modifier made of an organic solvent is mixed with a mobile phase for adjustment of separation of sample into components. In the back-pressure control valve, the pressure in the inlet flow path is as high as not less than 10 MPa in order to keep carbon dioxide in a mobile phase in a supercritical state. Further, the pressure in the outlet flow path is an atmospheric pressure. Thus, the pressure in the gap between the pressure control surface and the valve element falls rapidly.

As a result, cavitation occurs in the mobile phase in the back-pressure control valve. The pressure control surface of the back-pressure control valve is eroded due to cavitation. Such erosion is likely to occur in a case where a modifier including an organic solvent in particular is used.

As such, Patent Document 1 describes that the pressure control surface of the back-pressure control valve is coated with DLC (Diamond-Like Carbon) having hardness higher than that of a hard material of the pressure control block. Thus, erosion of the pressure control surface is suppressed.

On the other hand, it is desired to further improve the durability and lifetime of the back-pressure control valve by further suppressing erosion of the pressure control surface of the back-surface control valve.

An object of the present invention is to provide a back-pressure control valve durability and lifetime of which are improved.

### Solution to Problem

As results of various repeated experiments and studies, the inventor of the present invention has discovered that it was possible to suppress erosion caused by cavitation by forming the pressure control surface of the back-pressure control valve using a soft material conversely rather than forming the pressure control surface using a hard material, and created the following invention.

A back-pressure control valve according to one aspect of the present invention includes a main body having an inner space, a valve element that is arranged in the inner space of the main body and has an opposing surface opposite to one surface of the inner space, a driver that moves the valve element such that a distance between the opposing surface of the valve element and the one surface in the inner space changes, and a resin coating formed on one of the one surface in the inner space and the opposing surface of the valve element, wherein the main body has a first flow path that guides a fluid to a pressure control space formed between another surface out of the one surface and the opposing surface of the valve element, and the resin coating, and a second flow path that discharges a fluid from the pressure control space.

### Advantageous Effects of Invention

With the present invention, a back-pressure control valve durability and lifetime of which are improved can be provided.

### BRIEF DESCRIPTION OF THE DRAWINGS

FIG. 1 is a cross sectional view showing the structure of a back-pressure control valve.

FIG. 2 is a schematic diagram showing one example of the configuration of a supercritical fluid chromatograph.

FIG. 3 shows images representing results of a first durability test in regard to the back-pressure control valve.

FIG. 4 shows images representing results of a second durability test in regard to the back-pressure control valve.

### DESCRIPTION OF EMBODIMENTS

A back-pressure control valve and a supercritical fluid chromatograph including the back-pressure control valve according to embodiments will be described below in detail with reference to the drawings.

### (1) Configuration and Operation of Back-Pressure Control Valve

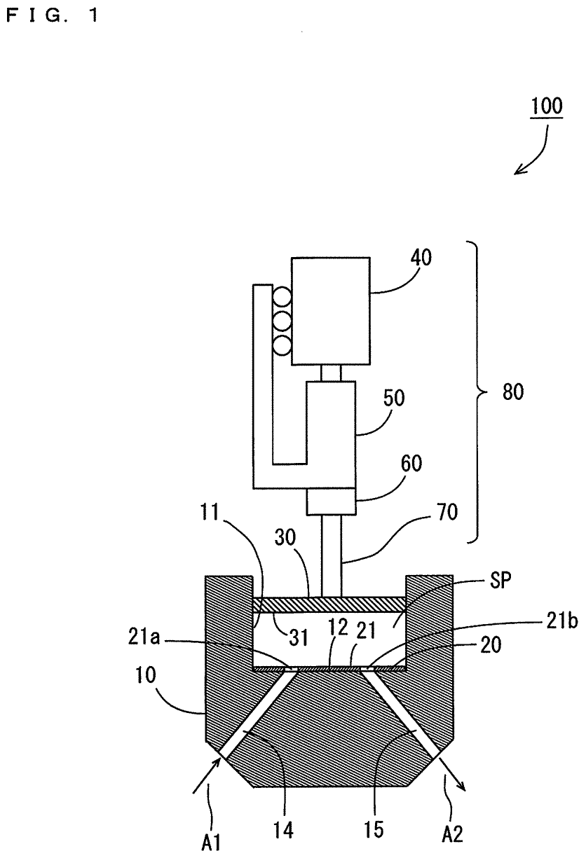

FIG. 1 is a schematic cross sectional view showing the configuration of the back-pressure control valve 100. The back-pressure control valve 100 of FIG. 1 includes a pressure control block 10, a resin coating 20, a diaphragm 30 and a driver 80. The pressure control block 10 is one example of a main body, and the diaphragm 30 is an example of a valve element.

The pressure control block 10 is formed of a hard material such as a metallic material. A metallic material is an example of a first material. In the present embodiment, the pressure control block 10 is formed of stainless. The material of the pressure control block 10 is not limited to this. A concave portion 11 is formed in an upper portion of the pressure control block 10. The concave portion 11 has a flat bottom surface 12. The upper end of the concave portion 11 is open. In the present embodiment, the concave portion 11 is columnar. The concave portion 11 is an example of an inner space.

An inlet flow path 14 extending obliquely upwardly from a lower portion in one side portion of the pressure control block to the concave portion 11 is formed. Further, an outlet flow path 15 is formed to extend obliquely upwardly from a lower portion in the other side portion of the pressure control block 10 to the concave portion 11. The inlet flow path 14 is an example of a first flow path, and the outlet flow path 15 is an example of a second flow path.

One end of the inlet flow path 14 opens at the outer surface of the pressure control block 10, and the other end of the inlet flow path 14 opens at the bottom surface 12. One end of the outlet flow path 15 opens at the outer surface of the pressure control block 10, and the other end of the outlet flow path 15 opens at the bottom surface 12.

The resin coating 20 is formed on the bottom surface 12 of the concave portion 11. The resin coating 20 is formed of resin having hardness lower than that of a metallic material. In the present embodiment, PEEK (polyetheretherketone) is used as a resin material. Due to the reasons described below, the thickness of the resin coating 20 is preferably not more than 50 μm. The thickness of the resin coating 20 is not less than 10 μm and not more than 50 μm, for example. Further, the thickness of the resin coating 20 is preferably not less than 10 μm and not more than 30 μm. Hereinafter, the upper surface of the resin coating 20 is referred to as a pressure control surface 21. In the resin coating 20, holes 21a, 21b that respectively communicates with the other end of the inlet flow path and the other end of the outlet flow path 15 are formed.

In the concave portion 11 of the pressure control block 10, the flat-plate shaped diaphragm 30 is arranged to be opposite to the pressure control surface 21. The diaphragm 30 is provided to be movable in an up-and-down direction in the concave portion 11. While the diaphragm 30 is formed of PBT (polybutylene terephthalate) in the present embodiment, the material of the diaphragm 30 is not limited to this. The diaphragm 3 may be formed of another resin material. A resin material is an example of a second material. A pressure control space SP is formed between the lower surface of the diaphragm 30 (hereinafter referred to as an opposing surface 31) and the pressure control surface 21.

In this manner, the pressure control space SP is formed of the opposing surface 31 of the diaphragm 30 formed of a resin material and the pressure control surface 21 of the resin coating 20. With such a configuration, both of the pressure control surface 21 and the opposing surface 31 are formed of a resin material that is softer than a metallic material. It is preferable that hardness of one of the pressure control surface 21 and the opposing surface 31 is high for highly accurate pressure control. Therefore, the thickness of the resin coating 20 is preferably small. Therefore, as described above, the thickness of the resin coating 20 is preferably not more than 50 μm.

The diaphragm 30 is driven by the driver 80 in the up-and-down direction. The driver 80 is constituted by a stepping motor 40, a mobile member 50, a piezo element 60 and a valve stem 70. The mobile member 50 is attached to a rotation shaft of the stepping motor 40. The valve stem 70 is attached to the upper surface of the diaphragm 30 to extend in the up-and-down direction. The piezo element 60 is attached between the mobile member 50 and the valve stem 70.

The rotation shaft of the stepping motor 40 is rotated, so that the mobile member 50 is moved in the up-and-down direction. Therefore, the position of the diaphragm 30 in the up-and-down direction can be roughly adjusted by rotation of the stepping motor 40. Further, the thickness of the piezo element 60 changes in accordance with an applied voltage. Therefore, it is possible to finely adjust the position of the diaphragm 30 in the up-and-down direction by changing a voltage applied to the piezo element 60. Thus, the gap amount between the pressure control surface 21 and the opposing surface 31 of the diaphragm 30 can be adjusted by an operation of the driver 80. That is, the volume of the pressure control space SP can be adjusted.

When the back-pressure control valve 100 is operated, a mobile phase is supplied to the pressure control space SP through the inlet flow path 14 and the hole 21a as indicated by the arrow A1. As indicated by the arrow A2, a mobile phase in the pressure control space SP is discharged to outside of the pressure control block 10 through the hole 21b and the outlet flow path 15. In this case, the driver 80 adjusts the gap amount between the pressure control surface 21 and the opposing surface 31 of the diaphragm 30, whereby the pressure of the mobile phase supplied through the inlet flow path 14 can be controlled. A downstream portion of the outlet flow path 15 is open to an atmospheric pressure.

At this time, the pressure of the mobile phase in the upstream portion of the pressure control space SP is as high as the pressure control 10 MPa to 40 MPa. In contrast, the pressure of the mobile phase in the downstream portion of the pressure control space SP is close to an atmospheric pressure. Therefore, cavitation is likely to occur in the pressure control space SP. In the present embodiment, the pressure control surface 21 is formed of the upper surface of the resin coating 20. Thus, erosion of the pressure control surface 21 caused by cavitation is suppressed as described below.

### (2) Supercritical Fluid Chromatograph

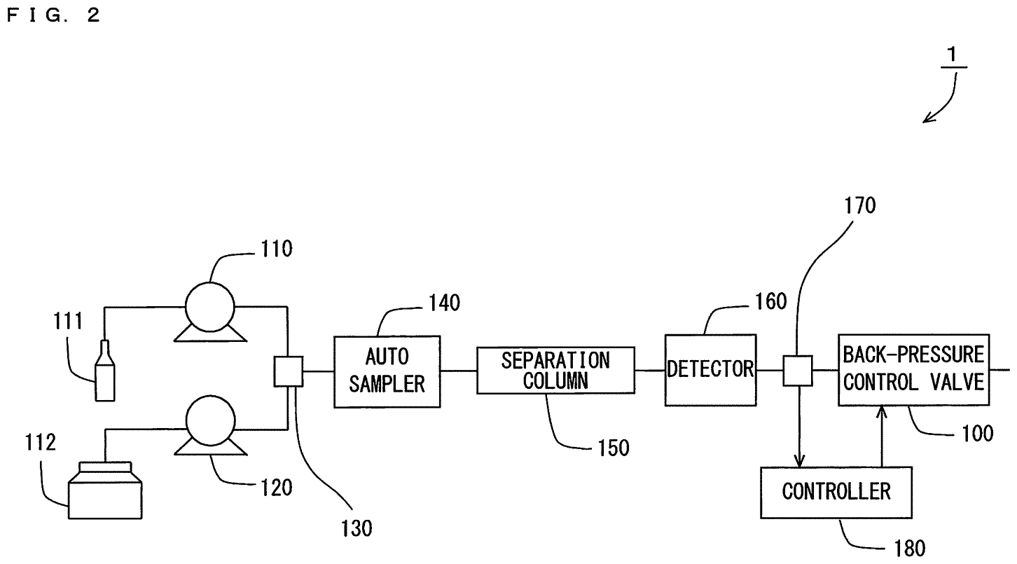

FIG. 2 is a schematic diagram showing one example of the configuration of the supercritical fluid chromatograph using the back-pressure control valve 100 of FIG. 1. The supercritical fluid chromatograph 1 of FIG. 2 includes a CO₂ pump 110, a modifier pump 120, a mixer 130, an autosampler 140, a separation column 150, a detector 160, a pressure sensor 170, a controller 180 and the back-pressure control valve 100.

The CO₂ pump 110 extracts carbon dioxide (CO₂) from a cylinder 111 while pressurizing carbon dioxide. The modifier pump 120 extracts a modifier from a modifier container 112. In the present embodiment, methanol is used as a modifier. The mixer 130 mixes the carbon dioxide extracted by the CO₂ pump with the modifier extracted by the modifier pump 120, and supplies a liquid mixture to the separation column 150 as a mobile phase through the autosampler 140.

The autosampler 140 introduces a sample into the mobile phase supplied to the separation column 150 from the mixer 130. A mobile phase and a sample are introduced into the separation column 150. The separation column 150 separates an introduced sample into components. The mobile phase and sample that have been led out from the separation column 150 flow through a flow cell of the detector 160. The detector 160 detects the components of sample in the mobile phase flowing through the flow cell.

The mobile phase and sample that are led out from the flow cell of the detector 160 flow into the inlet flow path 14 of the back-pressure control valve 100 of FIG. 1 and flows out from the outlet flow path 15. The pressure sensor 170 detects the pressure at a position farther upstream than the back-pressure control valve 100. The controller 180 controls the driver 80 of the back-pressure control valve 100 based on the pressure detected by the pressure sensor 170. Thus, the pressure at a position farther upstream than the back-pressure control valve 100 is adjusted to a set value. Carbon dioxide extracted from the CO₂ pump 110 is kept in a liquid in a supercritical state by the pressure control carried out by the back-pressure control valve 100 and the temperature control carried out by a cooling device (not shown).

### (3) Inventive Example and Comparative Example

A durability test, described below, was carried out with use of the supercritical fluid chromatograph 1 of FIG. 2 in order to evaluate durability of the back-pressure control valve 100 according to the present embodiment. In an inventive example, the back-pressure control valve 100 of FIG. 1 was used. In a comparative example, a back-pressure control valve, having the same configuration as the back-pressure control valve 100 of FIG. 1 except that a DLC coating was formed instead of the resin coating 20 on a bottom surface 12 of a concave portion 11 of a pressure control block 10, was used. The durability test was also carried out in regard to a reference example. In the reference example, a back-pressure control valve, having the same configuration as the back-pressure control valve 100 of FIG. 1 except that a bottom surface 12 of a concave portion 11 of a pressure control block 10 was exposed, was used. In the back-pressure control valve of the reference example, a pressure control surface is formed of stainless of a pressure control block.

First, a first durability test was carried out with use of the back-pressure control valves of the inventive example, the comparative example and the reference example. In the first durability test, a mobile phase was supplied to a back-pressure control valve at a relatively large flow rate. Further, a second durability test was carried out using the back-pressure control valves of the inventive example and the comparative example. In the second durability test, a mobile phase was supplied to a back-pressure control valve at a relative small flow rate.

In the first durability test, a mobile phase was supplied to the back-pressure control valve of each of the inventive example, the comparative example and the reference example from an inlet flow path at a flow rate of 80 mL/min, and the pressure in an upstream portion of the back-pressure control valve was set to 15 MPa. Methanol was mixed with a mobile phase as a modifier. The concentration of modifier of the mobile phase is 20%.

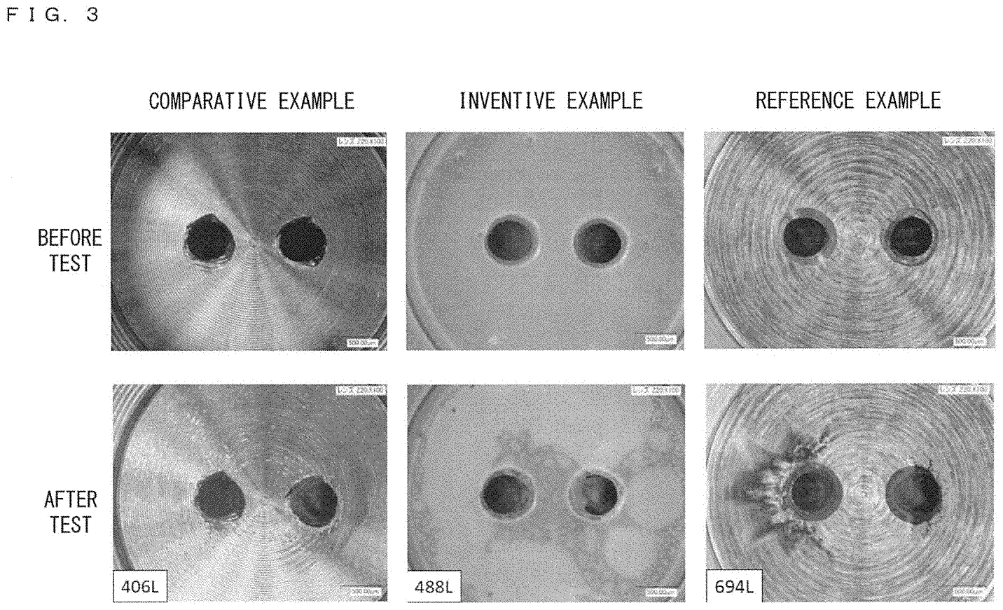

FIG. 3 shows images representing results of the first durability test in regard to the back-pressure control valves of the comparative example, the inventive example and the reference example. In FIG. 3, the images of the pressure control surfaces before and after the first durability test are shown.

In FIG. 3, the upper left image shows the pressure control surface before the test in the comparative example, and the lower left image shows the pressure control surface after the test in the comparative example. In the comparative example, after 406 liters of a mobile phase was supplied to the back-pressure control valve, the pressure control surface made of a DLC coating was already eroded.

In FIG. 3, the upper central image shows the pressure control surface before the test in the inventive example, and the lower central image shows the pressure control surface after the test in the inventive example. In the inventive example, even after a mobile phase of 488L was supplied to the back-pressure control valve, the pressure control surface made of the resin coating was hardly eroded.

In FIG. 3, the upper right image shows the pressure control surface before the test in the reference example, and the lower right image shows the pressure control surface after the test in the reference example. In the reference example, after 694 liters of a mobile phase was supplied to the back-pressure control valve, a large area of the pressure control surface formed of stainless was eroded.

Next, in the second durability test, a mobile phase was supplied from the inlet flow path 14 to the back-pressure control valve of each of the inventive example and the comparative example at a flow rate of 1.5 mL/min, and the pressure in the upstream portion of the back-pressure control valve was set to 10 MPa. Methanol to which 0.1% of trifluoroacetic acid was added was mixed with the mobile phase as a modifier. The concentration of modifier in the mobile phase is 40%.

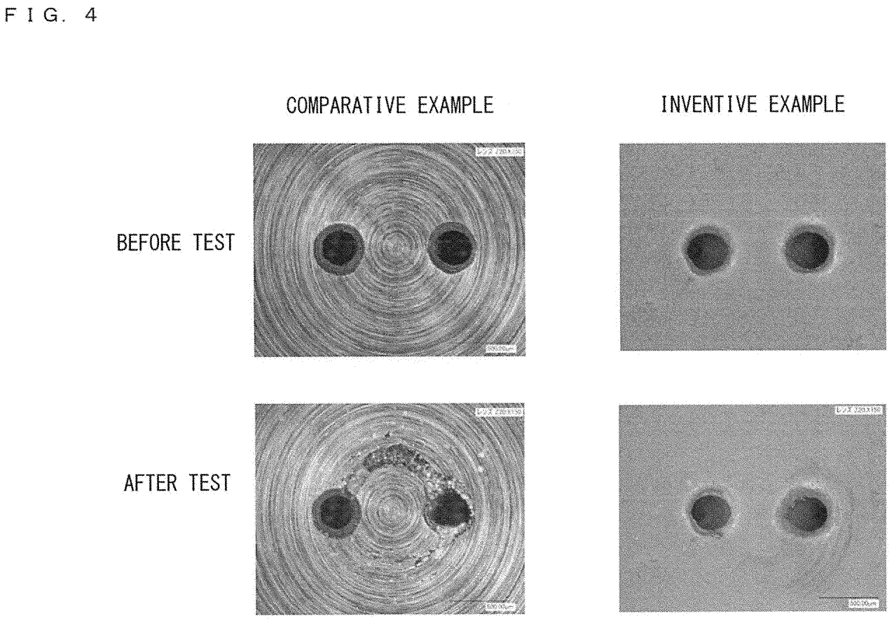

FIG. 4 shows images representing the results of the second durability test in regard to the back-pressure control valves of the comparative example and the inventive example. In FIG. 4, images of the pressure control surfaces before and after the second durability test are shown.

In FIG. 4, the left upper image shows the pressure control surface before the test in the comparative example, and the lower left image shows the pressure control surface after 8 hours has elapsed from the start of test in the comparative example. In the comparative example, the pressure control surface made of a DLC coating was eroded after about 68 hours has elapsed from the start of supply of the mobile phase to the back-pressure control valve. Thus, the hole in the inlet flow path was connected to the hole in the outlet flow path in the pressure control surface. As a result, it was difficult to control the pressure in the upstream portion of the back-pressure control valve to a set value.

In FIG. 4, the upper right image shows the pressure control surface before the test in the inventive example, and the lower right image shows the pressure control surface after about 222 hours has elapsed since the start of test in the inventive example. In the inventive example, the pressure control surface made of the resin coating was not eroded even after about 222 hours has elapsed from the start of supply of the mobile phase to the back-pressure control valve. Thus, a pressure could be controlled accurately even after the test.

From the results of the first durability test, in a case where the flow rate was relatively large such as the time when a sample was separated into components, it was found that erosion was sufficiently suppressed in the pressure control surface formed of the resin coating as compared to the pressure control surface formed of the DLC coating. Further, from the results of the second durability test, in a case where the flow rate was relatively small such as the time when sample components were analyzed, it was found that erosion of the pressure control surface made of the resin coating was suppressed although the pressure control surface formed of the DLC coating was eroded.

### (4) Effects of Embodiments

In the back-pressure control valve 100 according to the present embodiment, the resin coating 20 is formed on the bottom surface 12 of the concave portion 11 of the pressure control block 10. In this case, the pressure control surface 21 is formed of the upper surface of the resin coating 20. Thus, even in a case where a supercritical fluid including an organic solvent is supplied as a mobile phase to the space between the pressure control surface 21 and the opposing surface 31 of the diaphragm 30 for a long period of time, erosion of the pressure control surface 21 caused by cavitation is suppressed. As a result, the durability and lifetime of the back-pressure control valve 100 are improved.

### (5) Other Embodiments

In the above-mentioned embodiment, the pressure control block 10 is formed of a metallic material, the diaphragm 30 is formed of a resin material, and the resin coating 20 is formed on the bottom surface 12 of the pressure control block 10. However, the pressure control block 10 may be formed of a resin material, the diaphragm 30 may be formed of a metallic material, and the resin coating 20 may be formed on the opposing surface 31 of the diaphragm 30.

While the resin coating 20 is formed of PEEK in the above-mentioned embodiment, the resin coating 20 may be formed of a ketone resin other than PEEK. Further, another resin having a mechanical property (compression stress, a tensile strength, etc.) similar to that of PEEK and having relatively high hardness may be used. For example, the resin coating 20 may be formed of Fluorine resin such as PTFE (Polytetrafluoroethylene). Further, the resin coating 20 may be formed of another resin such as PPS (Polyphenylene sulfide) or PBT (Polybutylene terephthalate).

While the back-pressure control valve 100 is used in the supercritical fluid chromatograph in the above-mentioned embodiment by way of example, the back-pressure control valve 100 may be used in a supercritical fluid extraction device (SPE).

### (6) Aspects

It is understood by those skilled in the art that the plurality of above-mentioned illustrative embodiments are specific examples of the below-mentioned aspects.

(Item 1) A back-pressure control valve according to one aspect may include a main body having an inner space, a valve element that is arranged in the inner space of the main body and has an opposing surface opposite to one surface of the inner space, a driver that moves the valve element such that a distance between the opposing surface of the valve element and the one surface in the inner space changes, and a resin coating formed on one of the one surface in the inner space and the opposing surface of the valve element, wherein the main body may have a first flow path that guides a fluid to a pressure control space formed between another surface out of the one surface and the opposing surface of the valve element, and the resin coating, and a second flow path that discharges a fluid from the pressure control space.

With the back-pressure control valve according to item 1, even in a case where a supercritical fluid including an organic solvent is supplied as a mobile phase to the space between the one surface of the inner space of the main body and the opposing surface of the valve element for a long period of time, erosion of the resin coating caused by cavitation is suppressed. As a result, the durability and lifetime of the back-pressure control valve can be improved.

(Item 2) The back-pressure control valve according to item 1, wherein the main body may be formed of a first material, the valve element may be formed of a second material that is softer than the first material, and the resin coating may be formed on the one surface of the inner space.

With the back-pressure control valve according to item 2, the pressure control space is formed between the resin coating formed on the one surface of the main body having hardness higher than that of the valve element, and the opposing surface of the valve element. Even in a case where cavitation occurs in this pressure control space, erosion of the resin coating can be suppressed.

(Item 3) The back-pressure control valve according to item 1, wherein the first material may be a metallic material, the second material may be a resin material, and the resin coating may have hardness lower than hardness of the metallic material.

According to the item 3, erosion of the one surface of the main body formed of a metallic material can be suppressed.

(Item 4) The back-pressure control valve according to item 1, wherein the resin coating may be formed of a ketone resin.

According to item 4, erosion of the resin coating formed of a ketone resin can be suppressed.

(Item 5) The back-pressure control valve according to item 1, wherein the resin coating may be formed of polyetheretherketone.

According to item 5, erosion of the resin coating formed of Polyetheretherketone can be suppressed sufficiently.

(Item 6) The back-pressure control valve according to item 1, wherein the resin coating may have a thickness of not more than 50 μm.

According to item 6, a pressure can be controlled with high accuracy.

1. A back-pressure control valve comprising:
a main body having an inner space;
a valve element that is arranged in the inner space of the main body and has an opposing surface opposite to one surface of the inner space;
a driver that moves the valve element such that a distance between the opposing surface of the valve element and the one surface in the inner space changes; and
a resin coating formed on one of the one surface in the inner space and the opposing surface of the valve element, wherein
the main body has a first flow path that guides a fluid to a pressure control space formed between another surface out of the one surface and the opposing surface of the valve element, and the resin coating, and a second flow path that discharges a fluid from the pressure control space.

2. The back-pressure control valve according to claim 1, wherein
the main body is formed of a first material,
the valve element is formed of a second material that is softer than the first material, and
the resin coating is formed on the one surface of the inner space.

3. The back-pressure control valve according to claim 2, wherein
the first material is a metallic material,
the second material is a resin material, and
the resin coating has hardness lower than hardness of the metallic material.

4. The back-pressure control valve according to claim 1, wherein
the resin coating is formed of a ketone resin.

5. The back-pressure control valve according to claim 1, wherein
the resin coating is formed of polyetheretherketone.

6. The back-pressure control valve according to claim 1, wherein
the resin coating has a thickness of not more than 50 μm.
